(19) United States
(12) Patent Application Publication
(10) Pub. No.: US 2026/0331005 A1
(43) Pub. Date: Oct. 22, 2026

(54) SHELF DIVIDER STOP MEMBER SYSTEM AND METHOD

(71) Applicant: Presence from Innovation, LLC, Hazelwood, MO (US)

(72) Inventor: Kent L. Hanners, St. Charles, MO (US)

(21) Appl. No.: 19/180,322

(22) Filed: Apr. 16, 2025

(51) Int. Cl. G09F 3/20; A47F 5/00

(52) U.S. Cl. CPC G09F 3/208; A47F 5/0093

(57) ABSTRACT

A shelving system includes a product shelf for supporting a product. The system further includes a product stop at its proximal end that is selectively engageable with the shelf. The product stop includes a first display portion and a second display portion. The first display portion and the second display portion are removable. The product stop further includes an upper lipped channel and a lower lipped channel. The first display portion slidably engages in the upper lipped channel and the second display portion slidably engages in the lower lipped channel.

### CROSS-REFERENCE TO RELATED APPLICATIONS

None.

### FIELD OF INVENTION

The present invention relates to a system and method of an auto-glide shelving system with an improved product stop member design.

### BACKGROUND

It is common practice to provide product display devices and shelving systems to organize and display merchandise and products to consumers. Existing designs of a shelving system use various methods of bringing product forward from the distal end to the proximal end of the shelving system. The existing designs can be supported in either a flat horizontal position or in an inclined position for gravity-fed products. In gravity-fed existing designs, gravity operates to move a product forward toward the proximal end. The gravity-fed designs generally do not use a shelf pusher. Other existing designs may use a pull tab (pull string) that can be manually pulled to bring the product forward on the product shelf. In yet other designs, magnets may be used to move products forward toward the proximal end. Some existing designs, such as those in vending machines, use a coil spring to push products forward as product nearest the proximal end is removed. In other existing designs, a sheet coil, or ribbon spring, may be used to force the shelf pusher forward to bring the product forward on the product shelf.

These existing shelving systems may include a product stop to prevent the product from falling off the shelf as the product moves toward the proximal end. Some existing designs for a product stop include small rigid stops that extend vertically from the base. Other existing designs of product stops include a flexible gate at the proximal end. However, in existing designs of the product stop, the product stop is built into the base of the product shelf or into the sidewalls of each of the product channels. There exists a need for a product stop that is easily detached from the product shelf for easier repair, cleaning, restocking, and replacement.

Additionally, the shelving systems include a display. Many of the existing display designs include an analog display device, a paper display that is taped, glued, or otherwise secured to the product shelf, or simply do not have a front display on the product shelf.

### SUMMARY

The present disclosure relates generally to product display devices for use in storing and dispensing shelved products like beverages or snacks. In particular, various embodiments of a product merchandising display unit provide product display devices to organize and merchandise shelved products to consumers. Other product display devices have a plurality of product channels can be arranged adjacent to one another forming a product shelf shelving system.

The present disclosure overcomes the disadvantages and shortcomings with the known product shelving systems. The present disclosure generally relates to an auto-glide shelving system that includes a detachable product stop that selectively couples to the a proximal portion of a product shelf.

Additionally, the present disclosure generally relates to an auto-glide shelving system that includes a display portion on the front of the product shelf. The display mounts in the lipped front channel on the front of the product stop to quickly and easily remove the display portion and/or update the information being displayed.

### BRIEF DESCRIPTION OF THE DRAWINGS

FIG. 1 is an isometric view of a shelving system with a shelf pusher at a proximal end;

FIG. 2 is a partial perspective view of a front product stop of the shelving system of FIG. 1, wherein the front product stop is engaged with a side wall member of the shelving system;

FIG. 3 is a partial perspective view of a front product stop of the shelving system of FIG. 1, wherein the front product stop is disengaged with a side wall member of the shelving system;

FIG. 4 is an exploded view of an upper display portion and a lower display portion of the front product stop disengaged from the front product stop of FIGS. 2 and 3; and

FIG. 5 is a partial elevation view of an upper lipped front channel and lower lipped front channel receiving the upper display portion and lower display portion of FIG. 4.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

In some instances, a shelving system may be used in a merchandising cooler to bring product forward each time an item is purchased. In other instances, a shelving system may be used in grocery stores or other shopping centers to bring product forward ensuring that the product remains visible at the proximal end of the product shelf. For example, a shelving system may be used for, but is not limited to, canned or bottled beverages which easily maneuver linearly down a product channel. In another example, a shelving system may be used for, but not limited to, other canned goods, jarred goods, and other products housed in containers, cylindrical glass or other vessel. In some instances, the product shape may be, but is not limited to, a cylindrical shape, a substantially cylindrical shape, a square or cubic shape, etc.

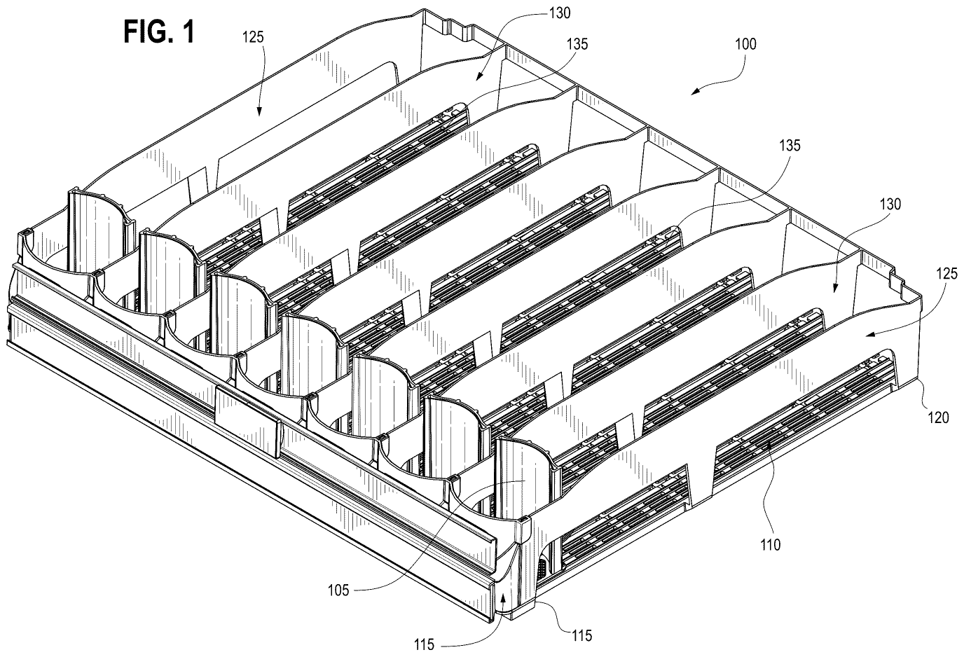

In FIG. 1, an auto-glide shelf 100 (referred to herein as the “shelf 100) is provided. The shelf 100 may include a shelf pusher 105 upon which product can be placed and moved along a shelf floor 110. The shelf floor 110 may include a proximal end 115 and a distal end 120. Product preferably travels from the distal end 120 toward the proximal end 115 as product is selected by a consumer for purchase and/or consumption. FIG. 1 depicts a first configuration of the shelf 100 where the shelf pusher 105 is located near the proximal end 120.

The shelf 100 further includes two side wall members 125 that project upwardly from the shelf floor 110 to retain product on the shelf 100 and help prevent it from falling off the shelf 100. Additional divider members 130 may be provided that are positioned and located between the side wall members 125. The divider members 130 preferably define product channels 135 therebetween through which shelf pushers 105 (and products thereon) may slide. The shelf 100 may include a plurality of product channels 135. In this instance, there are seven product channels 135 for dispensing product. In other instances, the product shelf 100 may include more or fewer product channels 135.

In instances where the product channel 135 is stocked with product in a queue, the shelf pusher 105 may start at the distal end 120 of the shelf 100 with a most distal product sitting on the shelf pusher 105 (not illustrated) and at least one product in front of the product on the shelf pusher 105 in a queue-like manner. A fully stocked product queue may stretch from the distal end 120 to the proximal end 115 in the product channel 135, and the shelf pusher 105 is in a most-distal position of the product channel 135.

In other instances when the product in the product queue does not fill up the full length of the product channel 135, the shelf pusher 105 may not start at the most-distal position at the distal end 120 of the shelf 100, but rather somewhere between the distal end 120 and the proximal end 115 of the shelf 100. As each one of the product(s) is removed from the proximal end 115, the shelf pusher 105 (and product thereon and in front thereof) may move forward from the distal end 120 toward the proximal end 115 of the product shelf 100 until the most-proximal product in the product queue in the product channel 135 reaches a product stop 140 protruding upwardly from the proximal end 115. The shelf pusher 105 may move in a variety of methods and mechanisms.

The front product stop 140 may be either flat or curved. In one instance, for example, the curved front product stop 140 may be designed to mate with cans or bottles. In FIG. 1, the front product stop is generally curved to complement the shape of a beverage can or bottle.

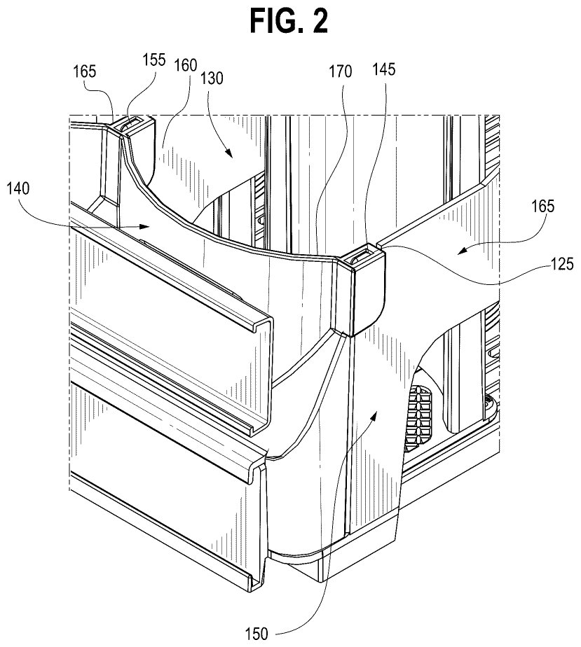

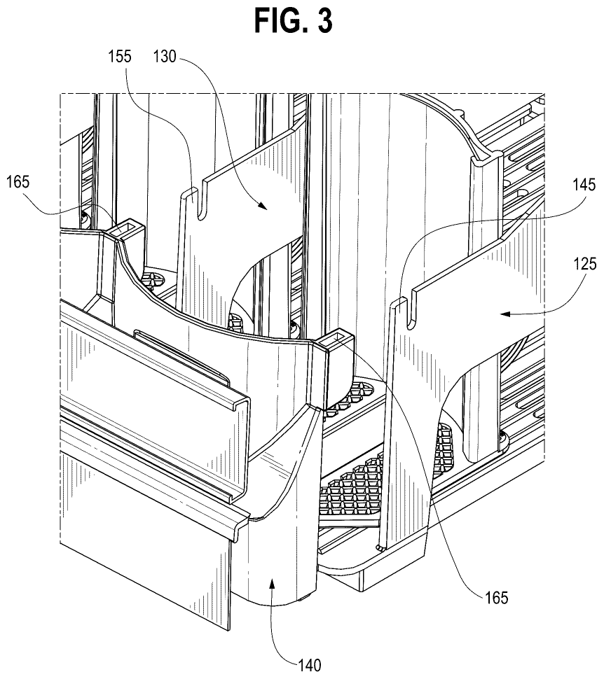

FIG. 2 illustrates the front product stop 140 attached to each of a side wall member 125 and a divider member 130. FIG. 3 illustrates the front product stop 140 detached from each of a side wall member 125 and a divider member 130.

Each side wall member 125 preferably includes an upward extending projection 145 near a front side 150 of the side wall member 125. Similarly, each divider member 130 preferably includes an upward extending projection 155 near a front side 160 of the divider member 130.

The projections 145, 155 are preferably configured to engage with elongated receiving members 165 formed at a top portion 170 of the product stop 140. The receiving members 165 may be positioned and located to align with the side wall members 125 and divider members 130 of the shelf 100. When the projections 145, 155 are received within the receiving members 165 (see FIG. 2), the product stop 140 is preferably releasably engaged to the shelf 100. To remove the product stop 140 for cleaning, replacement, repair, etc., one may lift the product stop 140 upwardly and away from the shelf 100 to disengage the projections 145, 155 from the receiving members 165 (see FIG. 3).

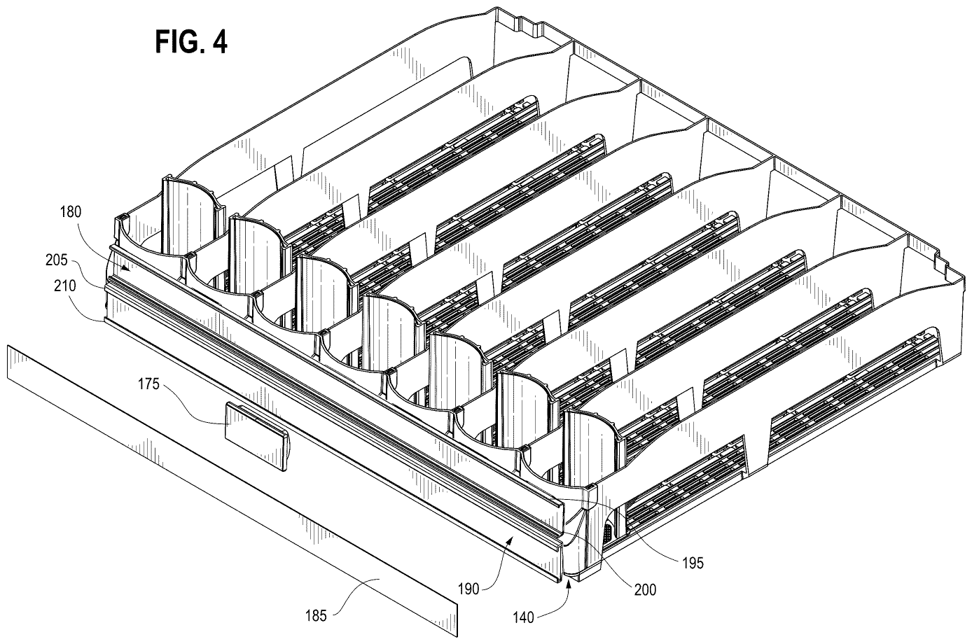

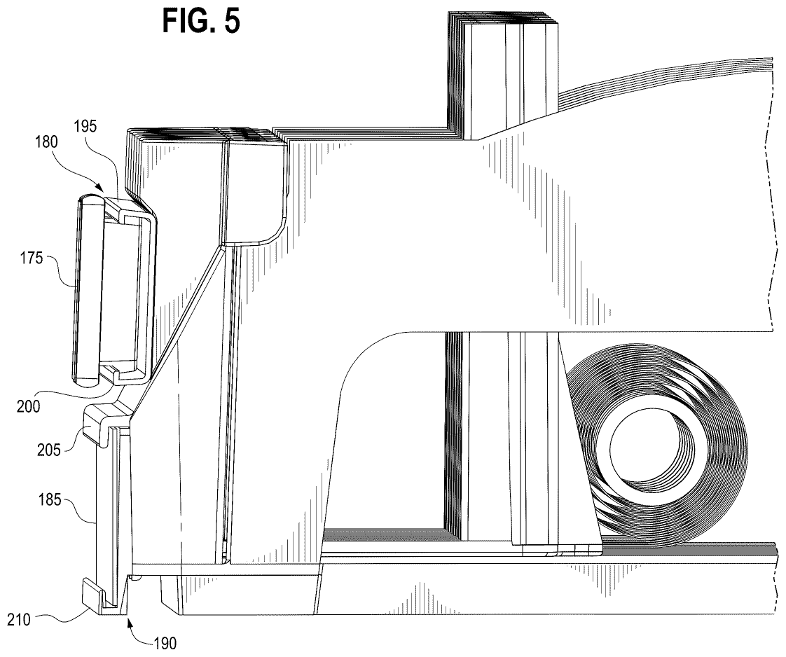

Turning to FIG. 4, the product stop 140 may include an upper display portion 175 that is selectively receivable in an upper lipped front channel 180 and a lower display portion 185 that is receivable in a lower lipped front channel 190. FIG. 5 shows each of the upper display portion 175 received in the upper lipped front channel 180, and the lower display portion 185 received in lower lipped front channel 190.

The upper lipped front channel 180 may be an elongated channel that has a first, upper lip 195 and a second, lower lip 200. When the upper display portion 175 is received by the upper lipped front channel 180, the upper lip 195 and the lower lip 200 may secure the upper display portion 175 in the upper lipped front channel 180.

The upper display portion 175 may be used to display product information such as the product name and a price for purchase. In some instances, the upper display portion 175 may be an electronic or digital display. The digital display allows for the product information to be edited and updated quickly. In some instances, the product information may be updated by a user while slidably engaged in the upper lipped front channel 180. In some instances, the electronic or digital upper display portion 175 may have a height of between one to two inches and a width of between two to three inches.

In some instances, the upper display portion 175 may not need to be removed from the upper lipped front channel 180 while the product information is being edited. In some instances, the upper display portion 175 can be edited remotely. In some instances, the product information may be updated by a user while slidably engaged in the upper lipped front channel 180. In other instances, the upper display portion 175 may be printed product information on various materials such as plastic, paper, or other means to which a display can be formed. A user may remove the upper display portion 175 by sliding it laterally from the upper lipped front channel 180.

The lower lipped front channel 190 may be an elongated channel that has a first, upper lip 205 and a second, lower lip 210. The lower lipped front channel 190 is configured to receive the lower display portion 185. When the lower display portion 185 is received by the lower lipped front channel 190, the first lip 205 and the second lip 210 may secure the lower display portion 185 in the lower lipped front channel 190.

The lower display portion 185 may also be used to display product information. In some instances, the product information may include, but is not limited to, the product name and a price for purchase. The lower display portion 185 may be an electronic or digital display. In other instances, the lower display portion 185 may be printed product information on various materials such as plastic, paper, or other means to which a display can be formed or printed on.

The lower display portion 185 is preferably removeable for ease of replacing the product information with updated product information. A user may remove the printed display information by sliding the lower display portion 185 laterally from the lower lipped front channel 190. A user may easily replace the printed display information by inserting an updated printed display into the lower lipped front channel 190.

In some instances, the lower display portion 185 may have a height of between one to two inches and a width of between two to three inches.

In some instances, the lower display portion 185 may not need to be removed from the lower lipped front channel 190 while the product information is being edited. In some instances, the lower display portion 185 can be edited remotely..

In other instances, other configurations are possible. For example, those of skill in the art will recognize, according to the principles and concepts disclosed herein, that various combinations, sub-combinations, and substitutions of the components discussed above can provide appropriate control for a variety of different configurations of auto-glide shelving systems for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A shelving system comprising:
a product shelf for supporting a product thereon;
a product stop at a proximal end of the product stop, the product stop comprising a first display selectively removable from the product stop.

1. The system of claim 1, wherein the first display portion is a digital display.

2. The system of claim 1, further comprising an upper lipped channel, wherein the first display portion slidably engages in the upper lipped channel.

3. The system of claim 3, wherein the upper lipped channel includes a first lip and a second lip.

4. The system of claim 4, wherein the first lip and the second lip of the upper lipped channel form around the first display portion.

5. The system of claim 1, wherein the product shelf further comprises a plurality of product channels separated by a plurality of dividers.

6. The system of claim 1, further comprising a lower lipped channel and a second display portion, wherein the second display portion slidably engages in the lower lipped channel.

7. A system comprising:
a product shelf for supporting at least one product;
a plurality of product channels defined by a plurality of dividers that extend upwardly from the product shelf;
a product stop at a proximal end, the product stop comprising a plurality of elongated receiving members configured to align with the dividers when the dividers are engaged with the product stop; and
a plurality of projections positioned and located on the dividers, the plurality of projections configured to be received within the elongated receiving members of the product stop when the product stop is engaged to the dividers.

1. The system of claim 8, the product stop further comprising:
at least one of a first display portion and a second display portion, wherein the at least one of a first display portion and the second display portion are selectively removable.

1. The system of claim 9, wherein the product stop further includes at least one of an upper lipped channel configured to receive the first display portion and a lower lipped channel configured to receive the second display portion.

2. The system of claim 10, wherein the product stop includes each of the upper lipped channel and the lower lipped channel, each of the upper lipped channel and the lower lipped channel having a first lip and a second lip.

3. The system of claim 11, wherein the first lip and the second lip of the upper lipped channel form around the first display portion, and the first lip and the second lip of the lower lipped portion form around the second display portion.

4. The system of claim 9, wherein the first display portion is a digital display and the second display portion is a printed display.

5. The system of claim 13, wherein the product stop includes curved portions configured to abut curved product.

6. A shelving system comprising:
a product shelf for supporting an at least one product thereon;
a product stop at a proximal end of the shelving system, the product stop comprising:
a first display portion and a second display portion, wherein the first display portion and the second display portion display product information, and
an upper lipped channel and a lower lipped channel, wherein the first display portion is slidably engaged in the upper lipped channel and the second display portion is slidably engaged in the lower lipped channel.

1. The system of claim 15, wherein the upper display portion is a digital display and the lower display portion is a printed display.

2. The system of claim 15, wherein the upper lipped channel and the lower lipped channel each have a first lip and a second lip.

3. The system of claim 17, wherein the first lip and the second lip of the upper lipped channel are configured to secure the first display portion, and the first lip and the second lip of the lower lipped portion are configured to secure the second display portion.

4. The system of claim 15, the shelving system further comprising:
At least one projection positioned and located on at least one of a divider that separates a plurality of product channels, and
at least one receiving member positioned and located on the product stop, the at least one receiving member configured to receive and engage one of the at least one projections.

5. The system of claim 15, wherein the product information is replaced with updated product information.
